(19) United States
(12) Patent Application Publication
(10) Pub. No.: US 2010/0184631 A1
(43) Pub. Date: Jul. 22, 2010

(54) PROVISION OF VISCOUS COMPOSITIONS BELOW GROUND

(75) Inventors: Mark Turner, Reading (GB); Gary John Tustin, Cambridge (GB); Christelle Vatry, Notre Dame De Message (FR); Philip Sullivan, Bellaire, TX (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/355,061

(22) Filed: Jan. 16, 2009

(51) Int. Cl. C09K 8/584

(52) U.S. Cl. 507/219; 507/261

(57) ABSTRACT

A method of providing a viscous emulsion at a subterranean location accessible via a wellbore, begins by providing an aqueous/aqueous emulsion comprising two aqueous solutions which, at surface temperature and pressure, are able to co-exist as separate aqueous phases in contact with each other. The two phases contain respective solutes which are sufficiently incompatible that they cause phase separation. The dispersed phase is rich in one solute, which may be a thickening polymer, while continuous phase is rich in a second solute, which may comprise surfactant. A hydrophobic liquid is dispersed in this emulsion to become the dispersed phase of a viscous emulsion whose continuous phase is provided by the aqueous/aqueous emulsion. The hydrophobic liquid and the aqueous/aqueous emulsion may be pumped separately down the wellbore to the subterranean location, and allowed to mix there so as to form the viscous emulsion at the subterranean location. On mixing, surfactant from the aqueous/aqueous emulsion may migrate to the oil/water interface, allowing the aqueous phases to become one phase with the result that the emulsion is further thickened by any thickening polymer in its composition. Even more thickening can be achieved by crosslinking the thickening polymer.

### FIELD OF THE INVENTION

This invention relates to emulsion compositions and to their use in the provision of a viscous emulsion or gel at a subterranean location. That location may be within a subterranean hydrocarbon reservoir and the emulsion or gel may play a role in reservoir management and/or hydrocarbon production.

### BACKGROUND OF THE INVENTION

The phases of a two-phase emulsion may be referred to as the ‘dispersed’ or ‘internal’ phase and the ‘continuous’ or ‘external’ phase. Frequently one phase is an aqueous solution while the other is some kind of hydrophobic liquid which may be referred to as an oil phase hence leading to the common classification as ‘water-in-oil’ or ‘oil-in-water’ according to which phase is the dispersed phase.

The volume of the dispersed internal phase within an emulsion may exceed 50% of the total volume of the emulsion. An internal phase volume fraction of 0.74 (i.e. the internal phase is 74% of the total volume) has been noted as a critical value corresponding to an emulsion in which the internal phase takes the form of uniformly sized close-packed spherical droplets—see for example Solans et al., ‘Highly concentrated (gel) emulsions, versatile reaction media’ in Current Opinion in Colloid and Interface Science vol 8 page 156 (2003). As mentioned in this paper by Solans et al, so-called ‘high internal phase’ emulsions are known in which the internal phase exceeds this critical volume fraction (although not all documents refer to this when using the word ‘high’). Typically, the structure of such an emulsion resembles a gas/liquid foam with polyhedral droplets of the internal phase separated by thin films of the continuous phase. Emulsions in which the internal phase provides a very high volume fraction possess extremely high viscosity compared to that of the constituent phases and usually display non-Newtonian rheological behaviour.

There are numerous circumstances in connection with the extraction of fossil hydrocarbons, i.e. oil or gas, in which it is desired to place a viscous fluid or gel at a location in a subterranean wellbore or in a subterranean geological formation. Viscous fluids which have been used for such purposes include emulsions. U.S. Pat. No. 5,633,220, U.S. Pat. No. 6,291,406 and Society of Petroleum Engineers paper SPE 64978 disclosed oil-in-water emulsions in which the dispersed aqueous phase is a high percentage of the total volume. Oil-in-water emulsions in which the dispersed oil phase is a high percentage of the total volume have also been used for such purposes. U.S. Pat. No. 3,552,494 disclosed a fracturing fluid formed from a heavy crude or other oil dispersed in an aqueous phase; a range from 50 to 90 volume percent oil was mentioned. SPE 16413 described a fracturing fluid which was an oil-in-water emulsion where the aqueous phase contained a thickening polymer as well as an emulsifying surfactant so that the aqueous phase was referred to as ‘gelled water’. This paper mentioned a dispersed oil phase which is 60 to 70% of the total volume and the paper noted the instability of emulsions with a high fraction of dispersed oil phase. U.S. Pat. No. 3,710,865 and U.S. Pat. No. 4,442,897 also disclosed wellbore fluids in the form of oil-in-water emulsions with an aqueous phase containing polymer. U.S. Pat. No. 6,818,599 disclosed pumping a surfactant solution down a wellbore to form an unstable emulsion of subterranean oil with a hydrocarbon content in a range up to 70%. GB1347721, EP1207267 and SPE 65038 disclosed fracturing fluids intended to be pumpable from the surface, in which oil was dispersed in an aqueous phase thickened with cross-linked polymer.

Although simple emulsions of one hydrophilic phase and one hydrophobic phase are the most widely known, some other emulsions have been described including systems in which a water-in-oil emulsion becomes the dispersed phase within a continuous aqueous phase. Such an emulsion has been termed a water-in-oil-in-water or w/o/w emulsion. Oil-in-water-in-oil (o/w/o) emulsions have also been described. U.S. Pat. No. 7,338,924 disclosed a drive fluid formulated as a low viscosity oil-in-water-in-oil composition.

It is known to form an emulsion in which both phases are aqueous, yet the two aqueous phases remain separate, even though in direct contact with each other, because dissolved solutes within them are sufficiently incompatible that they cause segregation into two phases. One solute (or one mixture of solutes) is relatively concentrated in one phase and another solute (or mixture of solutes ) is relatively concentrated in the other phase. Such compositions have been referred to as ‘biphasic aqueous systems’ or as ‘water-in-water emulsions’ or as ‘aqueous/aqueous emulsions’; this latter term is preferred here. They have been used or proposed for possible use in various areas of technology, notably to give texture to foodstuffs, for extraction of biological materials, for the extraction of minerals and as personal washing compositions. It has been suggested that personal washing compositions formulated with two aqueous phases could also contain a hydrophobic material as a third phase: notably U.S. Pat. No. 5,785,979 proposes the incorporation of silicone oil and EP116422 proposes the incorporation of an oil which may be isopropyl myristate. Since these oils would be intended as additional constituents in what is essentially a washing composition, it would be expected that the amount included would be no more than a small percentage of the overall composition.

### SUMMARY OF THE INVENTION

We have now found that an aqueous/aqueous emulsion provides an advantageous starting point for the formation of a viscous emulsion to be placed below ground. A first aspect of this invention is a method of providing a viscous emulsion at a subterranean location accessible via a wellbore, comprising steps of:
i. providing an aqueous/aqueous emulsion comprising two aqueous solutions which, at surface temperature and pressure, are able to co-exist as separate aqueous phases in contact with each other, the two phases containing a plurality of dissolved solutes which segregate between the two phases such that at least one first solute is present at a greater concentration in the first aqueous phase than in the second aqueous phase while at least one second solute is present at a greater concentration in the second aqueous phase than in the first aqueous phase;
ii. providing a hydrophobic liquid;
iii. pumping both the hydrophobic liquid and the aqueous/aqueous emulsion down the wellbore to the subterranean location, and
iv. causing or allowing the hydrophobic liquid to mix with the aqueous/aqueous emulsion before or after pumping them both down the wellbore.

We have found that dispersing a hydrophobic liquid into an aqueous/aqueous emulsion is an easy process to perform, which facilitates mixing on site at the vicinity of the well head, and also facilitates mixing below ground. It is possible to produce emulsions with high viscosity and with good stability.

Pumping the hydrophobic liquid and the aqueous/aqueous emulsion separately to the subterranean location and mixing them there to form a viscous emulsion has the advantage of pumping two relatively mobile constituent materials rather than the more viscous emulsion which is formed from them, so that less pumping energy is required. Indeed, the viscous emulsion which is formed may be too viscous to pump so that mixing below ground is critical to providing such a viscous composition below ground. Forms of the invention in which mixing takes place below ground can be stated as a method comprising providing a hydrophobic liquid and a aqueous/aqueous emulsion as stated above, pumping both the hydrophobic liquid and the aqueous/aqueous emulsion down the wellbore and then causing or allowing them to mix underground so as to disperse the hydrophobic liquid as emulsified droplets within the aqueous/aqueous emulsion.

The viscosity of the emulsion made by means of the inventive process will depend on the amount of dispersed phase included in it. The hydrophobic phase may provide over 50% of the total volume of the emulsion and indeed the hydrophobic phase may well provide over 74% of the total volume so that the composition can be classified as a high internal phase emulsion. The hydrophobic phase may then provide over 80% and possibly over 90% or even over 95% by volume of the overall emulsion composition. The viscosity of the emulsion may be sufficiently high that it will take the form of a semi-solid gel.

The hydrophobic dispersed phase of this emulsion will be a liquid or liquid mixture which does not mix with pure water. This hydrophobic phase contrasts with the two aqueous phases of the aqueous/aqueous emulsion. Each of these aqueous phases would be able to mix with pure water and be diluted by that water, even though they do not mix with each other because of the incompatibility of the solutes within them.

The hydrophobic liquid which provides the dispersed phase may be such that it has a log₁₀Kow at 25° C. of at least 0.8 and possibly at least 1 or at least 2. Kow denotes the oil-water partition coefficient, a commonly used measure of hydrophobicity/hydrophilicity. The octanol-water partition coefficient of a substance is defined as

$$Kow = \frac{concentration in octanol}{concentration in water}$$

when the substance is allowed to dissolve in a mixture of octanol and water. It is usually convenient to refer to the logarithm of Kow. A detailed textbook reference is Sangster, James (1997). Octanol-Water Partition Coefficients: Fundamentals and Physical Chemistry, Vol. 2 of Wiley Series in Solution Chemistry. This hydrophilic liquid may be hydrocarbon and it may be convenient to use a refined petroleum fraction such as kerosene or diesel.

The emulsion which is formed by the process of this aspect of the invention will have a dispersed phase formed by the hydrophobic liquid and a continuous phase provided by the aqueous/aqueous emulsion. This continuous phase may itself be an aqueous/aqueous emulsion. However, in some forms of this invention, some solute from one or both phases of the aqueous/aqueous emulsion transfers to the hydrophobic dispersed phase or (if it has surface-active properties) concentrates at the interface between phases, as the hydrophobic liquid is dispersed into the aqueous/aqueous phase and in consequence the composition which is formed has a continuous phase which is a single aqueous phase in which the concentration of one or both solutes has been reduced relative to concentration in the aqueous/aqueous emulsion before the hydrophobic liquid was mixed with it.

When the continuous phase remains as an aqueous/aqueous emulsion, a second aspect of this invention may be defined as an emulsion comprising over 50% by volume of a hydrophobic phase dispersed within a continuous phase which is a aqueous/aqueous emulsion comprising two aqueous solutions which co-exist as separate aqueous phases in contact with each other, the two phases containing a plurality of dissolved solutes which segregate between the two phases such that at least one first solute is present at a greater concentration in the first aqueous phase than in the second aqueous phase while at least one second solute is present at a greater concentration in the second aqueous phase than in the first aqueous phase. As mentioned above, the amount of the hydrophobic phase may be over 74% and possibly over 80, 90 or 95% by volume of the emulsion.

An aqueous/aqueous emulsion used in the inventive process should consist of two phases under surface conditions, which may conveniently be defined as 25° C. and 1000 mbar pressure. As already mentioned, incompatibility between dissolved solutes causes segregation into two phases. One solute (or one mixture of solutes) is relatively concentrated in one phase and another solute (or mixture of solutes ) is relatively concentrated in the other phase. Aqueous/aqueous emulsions can be formed with one phase relatively rich in a solute which is a polymer while the other phase is relatively rich in a solute which is a different polymer (a polymer/polymer system exemplified by guar/polyethylene glycol). Other possible combinations of solutes are:
polymer/surfactant eg guar/non-ionic surfactant
polymer/salt eg polyethylene glycol/ammonium sulphate,
surfactant/salt eg sodium dodecyl sulphate/ammonium sulphate and
salt/salt eg tetrabutylammonium bromide/ammonium sulphate.

If the solute in one phase is a polymer, it may be a polymer with the ability to thicken water or an aqueous solution. Examples of such polymers include guar, other galactomannans, xanthan, diutan, scleroglutan and cellulose. The polymer may be a polysaccharide which has been chemically modified such as by introduction of hydroxyalkyl, carboxymethyl, carboxymethylhydroxyalkyl or polyoxyalkylene side chains. Examples of useful hydroxyalkyl galactomannan polymers include, but are not limited to, hydroxy C₁ to C₄-alkyl galactomannans, such as hydroxy C₁-C₄-alkyl guars. Preferred examples of such hydroxyalkyl guars include hydroxyethyl guar (HE guar), hydroxypropyl guar (HP guar), and hydroxybutyl guar (HB guar), and hydroxyalkyl guars of mixed alkyl chain length. Other substituted polysaccharides include carboxymethyl guar (CMG), carboxymethylhydroxypropyl guar (CMHPG) and carboxymethylhydroxyethylcellulose (CMHEC).

Another possibility is that the thickening polymer is synthetic, such as a polymer or copolymer of acrylamide, methacrylamide, acrylic acid or methacrylic acid. Acrylic acid-acrylamide copolymers, acrylic acid-methacrylamide copolymers, partially hydrolyzed polyacrylamides and partially hydrolyzed polymethacrylamides may be used.

The method of this invention is particularly advantageous when one solute is a thickening polymer. Although one phase of the aqueous/aqueous emulsion may have thickening polymer preferentially concentrated within it, the segregation into two aqueous phases with a second solute preferentially concentrated in the second aqueous phase can, provided the volume of the second phase is sufficient, have the effect of preventing the thickening polymer from increasing the apparent viscosity of the aqueous/aqueous emulsion to the extent which would be observed in a single phase aqueous solution.

The aqueous/aqueous emulsion may have thickening polymer concentrated in its dispersed phase while the second aqueous phase, richer in a second solute, is the continuous phase of the aqueous/aqueous emulsion. Such an emulsion behaves rheologically like a slurry of particles in the continuous phase, and (before the hydrophobic liquid is added) the apparent viscosity of this aqueous/aqueous emulsion is then influenced primarily by the viscosity of its continuous phase and not much at all by the viscosity of its dispersed phase.

The second solute in the aqueous/aqueous emulsion may be provided, or partially provided, by another polymer. Polymers which may be used for this purpose include polyethylene glycol of various molecular weights, polyvinyl alcohol and various substituted cellulosic polymers including alkyl substituted cellulose and hydroxy alkyl substituted cellulose. These polymers are available in various molecular weights. It is generally the case that a high molecular weight polymer is more effective to cause segregation into two aqueous phases than the same polymer with a lower molecular weight so that a smaller weight percentage of high molecular weight polymer may be sufficient.

However, it is preferred that the second solute is a surfactant which may be an anionic, cationic, zwitterionic or non-ionic surfactant. Surfactants which have been found suitable include the cationic surfactant cetyl trimethyl ammonium bromide, the anionic surfactant sodium dodecyl sulphate and hydrophilic alkyl ethoxylate non-ionic surfactants. Suitable non-ionic surfactants may have HLB values above 14 and may have a general formula

R(OCH₂CH₂)ₙOH

where R denotes an alkyl or alkenyl group of at least 14 carbon atoms, especially a group containing 16 or 18 carbon atoms such as palmityl, stearyl or oleyl, and n has a mean value of at least 12. Three commercially available examples of such surfactants are:
polyoxyethylene (100) stearyl ether where R in the formula above is stearyl and n has an average value of 100; HLB value 18, available as BRIJ 700
polyoxyethylene (20) stearyl ether where R in the formula above is stearyl and n has an average value of 20; HLB value 15.3 available as BRIJ 78
polyoxyethylene (20) oleyl ether where R in the formula above is oleyl and n has an average value of 20, HLB value 15, available as BRIJ 98.
   (BRIJ is a registered trademark of Croda International plc)

A further possibility is that the second solute is a mixture of a polymer and a surfactant which are sufficiently compatible that they remain in the same phase. For example an aqueous/aqueous emulsion might have a thickening polymer such as guar concentrated in its dispersed phase and a mixture of polyethylene glycol and a hydrophilic alkyl ethoxylate non-ionic surfactant concentrated in its continuous phase.

If the solute in one phase of the aqueous/aqueous emulsion comprises surfactant, it is likely that the surfactant molecules will migrate to the interface between the hydrophobic and aqueous phases when the hydrophobic liquid is added. This will deplete the concentration of surfactant in the bulk of the aqueous phase and such depletion of the surfactant concentration may allow the two aqueous phases of the emulsion to unite as a single aqueous phase.

In some forms of this invention, the dispersed phase of the aqueous/aqueous emulsion has a thickening polymer concentrated in it, while the continuous phase comprises surfactant concentrated within it. As mentioned above, segregation into two phases restricts the thickening effect of the polymer so that the aqueous/aqueous emulsion is a mobile fluid when the hydrophobic liquid is mixed into it (and of course before that mixing step). However, when the hydrophobic liquid is mixed into it, surfactant migrates to the interface between aqueous and hydrophobic phases, causing the two aqueous phases to unite as a single aqueous continuous phase which is thickened by the polymer. In consequence the thickening effect of the polymer adds to the viscosity of the emulsion. Stable, high viscosity emulsions can be made in this way, with a mixing procedure which is easy to carry out.

The solvent in an aqueous/aqueous emulsion is of course water. It may have some salts in it in addition to the first and second solutes (notably thickening material and second partitioning material) which segregate into the two phases. For instance a mixture containing a thickening polymer as first solute and a surfactant as second solute might have some salt(s) dissolved in the water to increase salinity or regulate the pH of the composition.

It is likely that the ratio by volume of the dispersed and continuous phases within the aqueous/aqueous emulsion will lie in a range from 70:30 or 60:40 to 40:60 or 30:70. The dispersed phase volume may be greater than the continuous phase volume so that the volume ratio lies in a range from 70:30 or 60:40 to 51:49. Proportions by weight of the first and second solutes in the aqueous/aqueous emulsion may lie in a range from 2:1 to 2:3 and possibly from 2:1 to 1:1.

The overall concentration of the first and second solutes in the aqueous/aqueous emulsion can be high, possibly up to 15% or 20% by weight of the whole aqueous/aqueous emulsion. However, it will generally be convenient to use a concentration in a range from 1% up to 10% by weight of the aqueous/aqueous emulsion and possibly not more than 8% or 5% by weight. If the aqueous/aqueous emulsion contains a thickening polymer, the amount of this polymer may be from 1% up to 10% or more of the aqueous/aqueous emulsion. If the aqueous/aqueous emulsion contains a surfactant, the amount of surfactant may be from 1% up to 5% or possibly more of the aqueous/aqueous emulsion.

In a development of the present invention the aqueous/aqueous emulsion comprises a solute which is a polymer and this polymer is cross linked, either before or after mixing with hydrophobic liquid to make the viscous emulsion. As a result the viscosity of the emulsion is increased by the crosslinkling of the polymer molecules and it may then have the form of a stiff semi-solid. Crosslinking may be brought about by adding a compound able to react with two polymer molecules. Crosslinking of polysaccharides, and some other polymers, can be accomplished with a number of compounds, including borates, compounds of aluminium and compounds of zirconium, titanium, chromium and other transition metals including iron, copper, zinc and vanadium. Borate crosslinkers include boric acid, sodium tetraborate, and encapsulated borates; borate crosslinkers are pH dependant and may be used with buffers and pH control agents such as sodium hydroxide, magnesium oxide, sodium sesquicarbonate, sodium carbonate, amines such as hydroxyalkyl amines, anilines, pyridines, pyrimidines, quinolines, and pyrrolidines, and carboxylates such as acetates and oxalates. Zirconium crosslinkers include zirconium lactate, zirconium carbonate, zirconium acetylacetonate, zirconium malate, zirconium citrate, and complexes with amines such as triethanolamine or diisopropylamine. Titanium-based crosslinkers include titanium lactate, titanium malate, titanium citrate, titanium ammonium lactate, titanium acetylacetonate and complexes with amines such as titanium triethanolamine. Aluminium crosslinkers include aluminum lactate and aluminum citrate. Chromium crosslinkers include chromium citrate, chromium acetate and chromium propionate.

Exemplary organic crosslinking agents include aldehydes such as acetaldehyde butyraldehyde, heptaldehyde and decanal which can cross-linked between polymer molecules by forming acetals with hydroxyl groups of more than one polymer molecule. Organic crosslinking agents may be bifunctional organic compounds such as dialdehydes or quinones Such organic crosslinkers include glutaraldehyde, terephthaldehyde and 1,4-benzoquinone. Crosslinking may be provided by molecules which react together. For example compounds with more than one phenol group. such as hydroquinone, resorcinol, catechol, phloroglucinol, pyrogallol, 4,4′-diphenol, 1,3-dihydroxynaphthalene and tannins have been used together with aldehydes as described, for example, in U.S. Pat. No. 4,440,228.

If a synthetic thickening polymer is present, this can likewise be crosslinked by the addition of a crosslinking agent able to react with two polymer molecules. Polyacrylamides can be crosslinked with phenol and formaldehyde: the crosslinking mechanism involves hydroxymethylation of the amide nitrogen, with subsequent propagation of crosslinking by multiple alkylation on the phenolic ring. Synthetic polymers can alternatively be crosslinked during manufacture by incorporating a crosslinking agent such as divinylbenzene during polymerisation.

An emulsion made in accordance with the present invention may include various optional constituents. One possibility is fibers. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Fibres which are hydrophilic may be useful to reinforce the aqueous/aqueous emulsion and thereby further enhance the viscosity of the overall composition when placed at a subterranean location. Available fibres include polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polyvinyl alcohol fibers and fibers made from polyesters of hydroxy acids such as polylactic acid and polyglycolic acid.

Embodiments of the invention may also use other additives and chemicals. Additives commonly used in oilfield applications include oxygen scavengers, scale inhibitors, corrosion inhibitors, fluid-loss additives, bactericides and iron control agents. Such materials may simply be added to the mixture, or maybe added in an encapsulated form to protect them until needed, or to keep them out of contact with the surrounding liquid for a time and then release them. Some examples of documents which describe encapsulation procedures are U.S. Pat. No. 4,986,354, WO 93/22537, and WO 03/106809.

Some water-miscible organic solvent may possibly be present in a composition according to this invention but since this is likely to hinder emulsification of the hydrophobic liquid in the aqueous/aqueous emulsion, the amount may be small, such as not more than 5% by weight of the aqueous emulsion and not more than 1% by weight of the entire composition. Preferably, water-miscible organic solvent is absent.

The overall process of preparation may begin with mixing the constituents of the aqueous/aqueous emulsion. Preferably this is carried out by mixing water with a solute which does not cause significant thickening and then mixing in any solute which does have ability to thicken water. Such an order of mixing leads directly to an aqueous/aqueous emulsion without difficulties normally encountered when mixing a thickening polymer with water. These mixing steps to form a biphasic aqueous/aqueous emulsion are preferably carried out at the surface before pumping downhole and may be carried out at the site where the well head is located. The hydrophobic liquid is then mixed with the aqueous/aqueous emulsion to form a viscous emulsion. This mixing step may be carried out below ground so that the viscous emulsion is formed at or proximate the subterranean location where it desired to place it.

Delivery of a mobile aqueous biphasic mixture to a subterranean location may be carried out in various ways including conventional methods used to place thickened fluids (although with expected savings in pumping energy). One possibility is that the mixture is simply pumped down a wellbore to a subterranean location. Where a wellbore encloses a production tube the aqueous biphasic mixture might be pumped down the production tube or down the annulus surrounding the production tube.

A further possibility is that the fluid is delivered by means of coiled tubing inserted into a wellbore. The term ‘coiled tubing’ is in widespread use to denote continuous tube which is drawn off from a storage reel and inserted temporarily into a wellbore for whatever distance is required. Because this tubing can be moved longitudinally within the bore, it can be used to place a fluid accurately at selected positions along the length/depth of a wellbore. These may be selected depths within a vertical wellbore and/or selected locations along a horizontal bore.

The aqueous viscous fluid which is delivered to a subterranean location in accordance with this invention may serve any of a diverse variety of purposes in connection with production of oil or gas from a subterranean reservoir. Possible functions include, but are not limited to:
zonal isolation of one region from another,
blocking a path of flow, thus diverting the path of flow of another fluid which is pumped subsequently,
stabilisation of a weak formation,
hydraulic fracturing, including acid fracturing,
spacer fluids to separate two other fluids,
blocking inflow from a water-containing region,
blocking a path of fluid loss,
water flood, driving oil or gas towards a production well,
remediation fluids to remove unwanted deposits,
wellbore clean out, removing unwanted residues from previous operations.

A category of particular interest is those functions where it is required to employ a composition which is oil based, for example because the reservoir formation is oil-wet.

Another category of particular interest is those functions where a very viscous gel is required, because this invention allows a biphasic mobile emulsion and a mobile hydrophobic liquid (which may be a petroleum fraction) to be pumped to a subterranean location where it is converted to a gel which is too viscous to pump.

Embodiments of the invention will now be further described and illustrated by way of example only with reference to the following drawings and detailed description.

### BRIEF DESCRIPTION OF THE DRAWINGS

FIGS. 1a and 1b are phase diagrams of aqueous mixtures capable of segregation into aqueous/aqueous emulsions;

FIG. 2 is a set of graphs of shear rate against shear stress for the samples and comparative samples of Example 3;

FIG. 3 is two sets of graphs of shear rate against shear stress for the samples of Example 4, with continuous lines for the graphs at 25° C. and dotted lines for the graphs at 80° C.;

FIG. 4 is a sets of graphs of viscosity against shear stress for the samples of Example 4, at 80° C.;

FIG. 5 plots yield stress values for the samples of Example 4 against their guar content, both at 25° C. (points shown as diamonds) and 80° C. (points as squares);

FIG. 6 plots yield stress values for the samples of Example 9 against their aqueous phase content, with points shown as diamonds for crosslinked polymer and as open squares for no crosslinking;

FIG. 7 plots elastic modulus values for the samples of Example 9 against their aqueous phase content, also with points shown as diamonds for crosslinked polymer and as open squares for no crosslinking;

FIG. 8 diagrammatically illustrates delivery of a composition into a wellbore by means of coiled tubing; and

FIG. 9 is a detail of the vertical part of the well of FIG. 8.

### DETAILED DESCRIPTION AND EXAMPLES

Throughout these Examples percentages of polymer and surfactant are given as percentages of the aqueous mixture before any hydrophobic liquid is added.

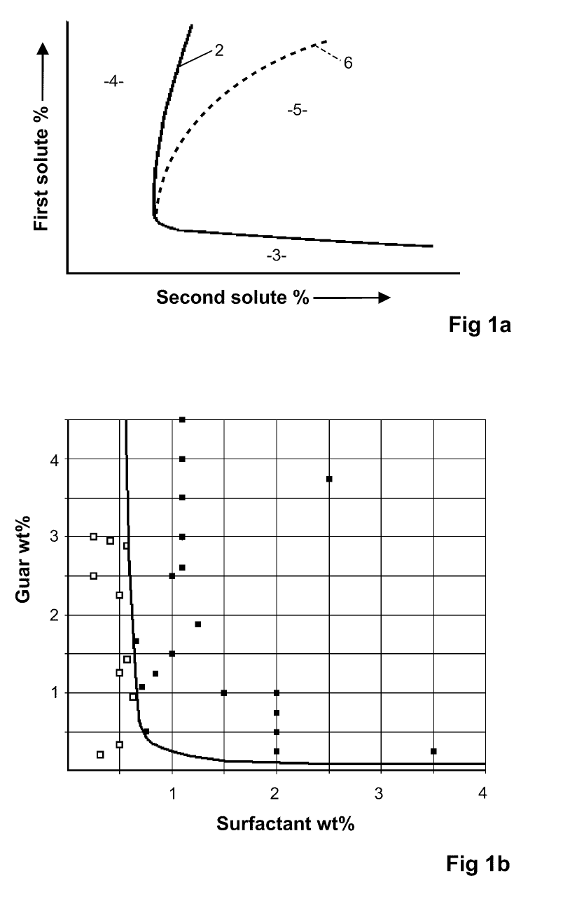

FIG. 1a shows schematically a phase diagram for aqueous/aqueous emulsions formed with first and second solutes in water. In this instance the solutes were both polymers, but this form of phase diagram is found with a range of solutes. The vertical axis is the concentration of a first solute which in this instance was guar, a thickening polymer. The horizontal axis shows the concentration of a second solute, which in this instance was polyethylene glycol (PEG), which has comparatively little thickening effect.

The curve 2 is the so-called binodal curve. In the area to the left and below this curve 2 aqueous solutions of the two solutes exist as a single aqueous solution. This solution might contain a small percentage of the first solute, as in the area 3 below the curve 2 or it might contain a small percentage of second solute as in the area 4 to the left of the curve 2. Towards the upper part of this area 4, where the concentration of thickening polymer is significant, the solution would be viscous because of the presence of the thickening polymer.

Above and to the right of the curve 2, in the area generally indicated 5, the composition segregates into two phases. One phase is rich in the first solute (guar) but contains only a small concentration of the second solute. The other phase is, conversely, rich in the second solute (PEG) but contains only a small concentration of the first solute. Below the curve 6 shown as a dashed line, the aqueous/aqueous emulsions are mobile fluids. In the area above the curve 6 but to the right of the binodal line 2 the aqueous/aqueous emulsion contains a high proportion of the guar-rich phase and is more viscous.

FIG. 1b shows the phase diagram for combinations of guar and the non-ionic surfactant BRIJ 700. Above and to the right of the binodal line (where the points are shown as solid squares) the compositions form biphasic aqueous/aqueous emulsions.

### EXAMPLE 1

### Preparation of Aqueous/Aqueous Emulsions

Aqueous mixtures were prepared from polysaccharide, nonionic surfactant and de-ionised (DI) water. The polysaccharide was guar and the surfactant was polyoxyethylene (20) oleyl ether (BRIJ 98). The surfactant was mixed with 200 ml of DI water and the guar was added as a dry powder while stirring vigorously in a WARING blender. Each sample was stirred rapidly in the blender for a minimum of one hour. After this stirring process, each sample was inspected visually, poured into a measuring cylinder and allowed to stand for a period of at least 24 hours to check for phase separation.

A mixture of 1.5 wt % guar and 3 wt % of the non-ionic surfactant in water was observed to form two phases existing as an aqueous/aqueous emulsion which was of low viscosity and easily pourable. Mixtures were also formed using 1.5 wt % guar and either 1 wt % surfactant or none at all. These fluids were viscous single phase compositions. These observations of viscosity were confirmed by measuring viscosities at 100 sec⁻¹ shear rate. Without surfactant or with 1 wt % of it, viscosity was 1 Pascal second but with 3 wt % surfactant it was 0.05 Pascal second.

### EXAMPLE 2

### Preparation of Aqueous/Aqueous Emulsion

A similar procedure to the previous example was used to make an aqueous/aqueous emulsion containing 3 wt % guar and 4 wt % of the BRIJ 98 non-ionic surfactant. In place of mixing in a WARING blender, an overhead stirrer with a four-blade impeller was used to stir the mixture for 20 minutes. The emulsion was observed to be of low viscosity and easily pourable. It was sufficiently stable that it could be kept for some days at room temperature.

### EXAMPLE 3

### Preparation of Viscous Emulsions

The aqueous/aqueous emulsion containing 3 wt % guar and 4 wt % of the BRIJ 98 non-ionic surfactant prepared as in the previous example was used to make samples of viscous emulsions containing 90 wt % kerosene dispersed in 10 wt % of the of aqueous/aqueous emulsion. A quantity of the aqueous/aqueous emulsion was stirred with the overhead stirrer and four-blade impeller at a speed of 800 rpm. Kerosene was slowly added in a continuous stream. After one-third of the kerosene had been added, the stirrer speed was increased to 1000 rpm and this speed was maintained while the remainder of the kerosene was added. Some samples were then subjected to a period of further mixing at an increased stirrer speed, as shown in the following table.

Further mixing

| Sample | Time (mins) | Speed (rpm) |
|---|---|---|
| G1 | none | |
| G2 | 2 | 1600 |
| G3 | 2 | 1800 |
| G4 | 10 | 2000 |

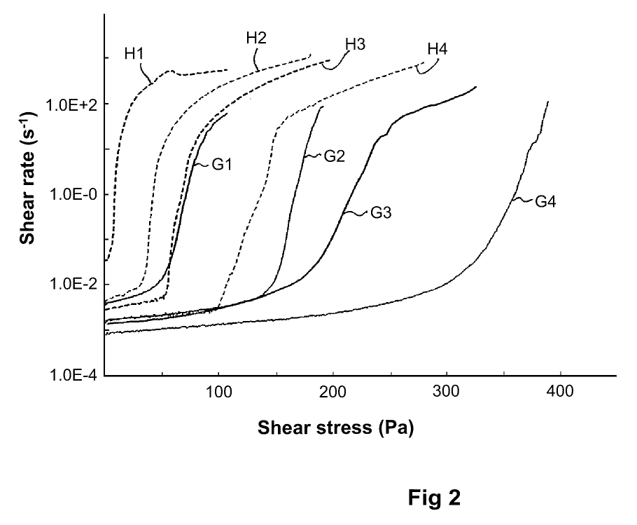

The rheology of each of these these compositions was measured at 25° C. using a Bohlin rheometer operated to report the values of shear rate as shear stress is progressively increased (a procedure referred to as a shear ramp). The results are shown as full lines in FIG. 2. The longer stirring times led to higher values of shear stress at shear rates of 10⁻² sec⁻¹ and faster.

A series of comparative compositions (designated H1 to H4) were made by the same procedures, using an aqueous solution containing 4 wt % of the non-ionic surfactant but no guar. These also formed viscous emulsions with the kerosene in the disperse phase. The rheologies of these compositions were measured in the same way and are shown by broken lines in FIG. 2. Once again longer stirring times led to higher values of shear stress, but each of these comparative compositions was of somewhat lower viscosity than the corresponding guar-containing composition prepared from an aqueous/aqueous emulsion.

The thickening effect of guar in the kerosene-containing emulsions G1 to G4 indicates that these emulsions had a continuous phase which was formed from the aqueous/aqueous emulsion when surfactant migrated to the oil-water interface at the surface of kerosene droplets, allowing the two phases of the aqueous/aqueous emulsion to coalesce into a single aqueous phase.

When examining the rheology of these various compositions, it was observed that the viscosity of each composition initially increased linearly as shear stress increased until a yield point was reached when the composition began to flow and then fractured with rapid collapse of viscosity. The highest value of shear stress reached was taken as the yield stress. The values of yield stress for these various samples were

| Sample | Yield stress (Pa) | Comparative Sample | Yield Stress (Pa) |
|---|---|---|---|
| G1 | 40 | H1 | 5 |
| G2 | 130 | H2 | 30 |
| G3 | 160 | H3 | 50 |
| G4 | 290 | H4 | 90 |

It is apparent that the samples G1 to G4 in which the continuous (i.e. external) phase contains guar had significantly higher yield stress than the corresponding comparative samples H1 to H4 in which the continuous phase was a surfactant solution without guar present.

### EXAMPLE 4

Aqueous mixtures were prepared, as in Example 2, all containing 4 wt % BRIJ 98 but containing varying percentages of guar, ranging from 0 to 9 wt %. These aqueous mixtures were then used to prepare viscous emulsions containing 90 wt % kerosene and 10% of the aqueous mixture, using the procedure of Example 3 without any continued stirring after kerosene addition.

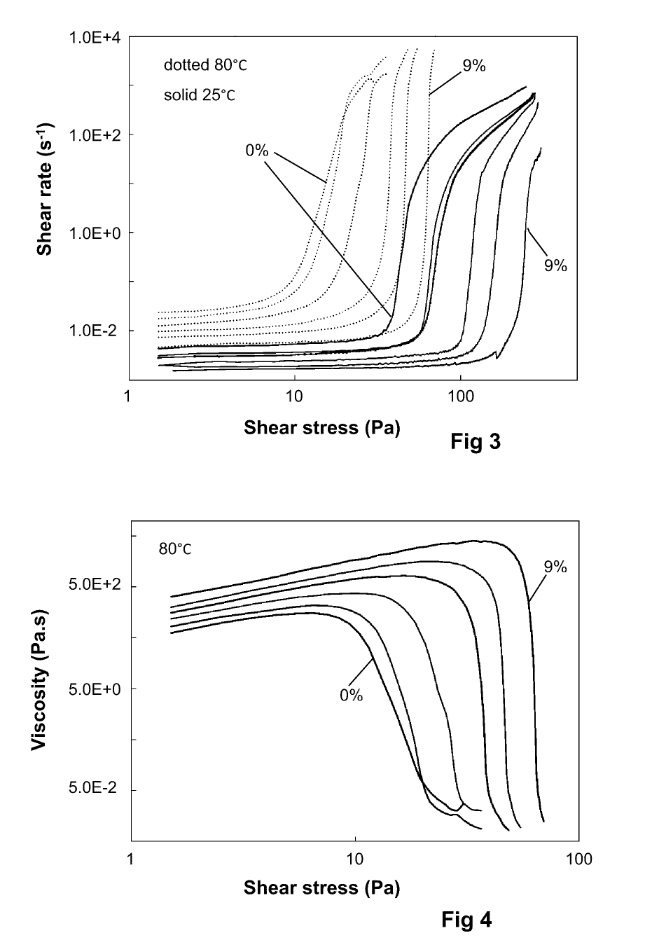

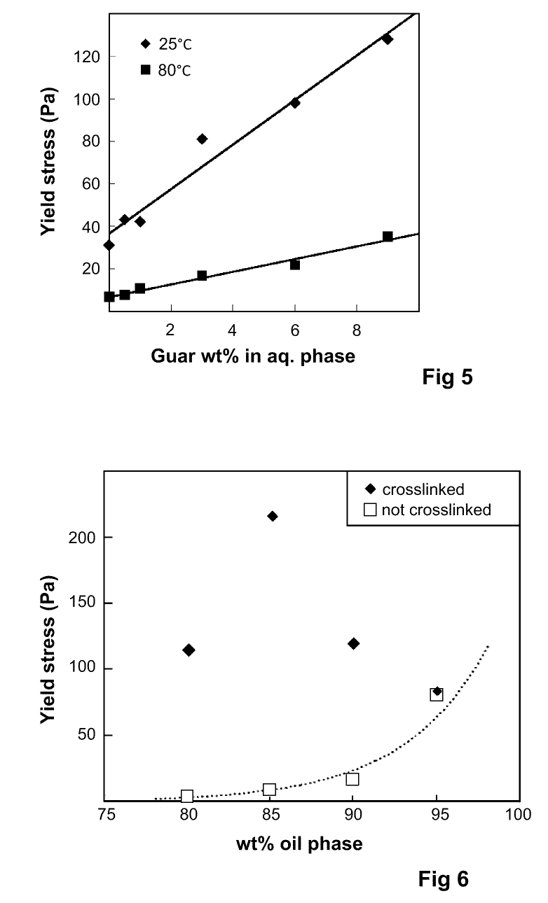

Even with 0.5% guar in the aqueous mixture, the kerosene-containing emulsions were sufficiently viscous that a sample placed in the middle of glass dish remained in place and did not flow out over the glass surface. These emulsions were observed to become progressively more viscous as the guar content increased. The Theological properties of these compositions were measured as in the previous Example and FIG. 3 shows the results at 25° C. (solid lines) and 80° C. (broken lines). FIG. 4 shows viscosity against shear stress for the same samples. All the curves show a region (to the left) in which shear stress increased linearly up to a yield point at which the sample began to flow and then fractured with dramatic loss of viscosity. Once again yield stress was taken to be the highest value of shear stress reached. FIG. 6 plots the values of the yield stress against guar content and shows that yield stress was linearly related to guar content.

### EXAMPLE 5

The procedure of Examples 2 and 3 (without additional stirring after kerosene addition) was used to make viscous emulsions containing 4 wt % surfactant and either 3 wt % guar or no guar in the aqueous mixture, analogous to sample GI and comparative sample H1 of Example 3, but using BRIJ 78 and BRIJ 700 surfactant in place of BRIJ 98. It was observed that the emulsions prepared using BRIJ 78 had very similar properties to corresponding emulsions prepared with BRIJ 98, as might be expected in view of their similar chemical structures and similar HLB values. However, using BRIJ 700 which has a longer polyoxyethylene chain and is more hydrophilic led to yield stress values which were three times greater at 25° C. and four times greater at 80° C.

Samples G1 and H1 from Example 3 and corresponding samples made in this Example using BRIJ 700 were subjected to constant shear stress at 80° C. until collapse occurred. The length of time until collapse of viscosity occurred was recorded and the recorded values are set out in the following table:

| | |
|---|---|
| | Time until |
| Guar concentration | collapse (min) |

| in aqueous mixture | BRIJ 98 | BRIJ 700 |
|---|---|---|
| 0% | 45 (H1) | 135 |
| 3% | 80 (G1) | 165 |

### EXAMPLE 6

100 g of a viscous emulsion was prepared using the same materials, quantities and procedure as for sample G1 of Example 3. 1 ml of 0.6 M boric acid was added during the mixing procedure so that the overall boron concentration of the emulsion composition was approximately 370 ppm. After this kerosene containing viscous emulsion had been prepared, crosslinking was induced by adding 200 mg of 0.1 M potassium hydroxide, dropwise, while stirring gently. Crosslinking occurred rapidly, within about one minute, and could be seen to increase the viscosity considerably.

### EXAMPLE 7

Aqueous compositions were prepared as in Example 2 using 4 wt % BRIJ 98 and 0.5, 1, 1.5 or 2 wt % of polyacrylamide. Kerosene was then added as in Example 3, without any additional stirring after kerosene addition. so as to form viscous emulsions. Some 100 g samples of these emulsions were then crosslinked by adding 75 mg of 5 wt % chromium (III) chloride solution with rapid overhead stirring at 1000 rpm. Following approximately 30 seconds of mixing, the sample was allowed to rest at room temperature. Crosslinking occurred gradually, and was complete within approximately 90 minutes. Optical micrographs of such a gel undergoing crosslinking showed the gradual formation of a fibrous polymer network.

Rheological properties of these gels, both with and without crosslinking, were measured as before and their values of yield stress are given in the following table.

| polyacrylamide in | Yield stress (Pa) | |
|---|---|---|
| aqueous/aqueous composition | without crosslinking | crosslinked |
| 0.5 wt % | 20 | 20 |
| 1 wt % | 20 | 120 |
| 1.5 wt % | | 220 |
| 2 wt % | 160 | 250 |

Elastic modulus was also determined for these samples. The results were:

| polyacrylamide in | Elastic modulus (Pa) | |
|---|---|---|
| aqueous/aqueous composition | without crosslinking | crosslinked |
| 0.5 wt % | 170 | 230 |
| 1 wt % | 210 | 400 |
| 1.5 wt % | | 500 |
| 2 wt % | 280 | 670 |

The crosslinked samples were subjected to constant shear stress at 80° C. and no emulsion breakdown was observed, showing that crosslinking of the polymer led to a viscous gel of considerable stability.

### EXAMPLE 8

### Varying the Oil-Water Ratio

Aqueous/aqueous emulsions were prepared as in Example 2 using 4 wt % BRIJ 98 and 1 wt % polyacrylamide. Kerosene was then added as in Example 3, without any additional stirring after kerosene addition, so as to form viscous emulsions. The proportions of aqueous/aqueous emulsion to kerosene were varied so as to make kerosene-containing emulsions with 5, 10, 15 and 20 wt % aqueous phase. The polyacrylamide in some of these emulsions was cross-linked as in Example 7. Rheology was measured as before and yield stress values are shown in FIG. 6.

The values for samples which were not crosslinked are shown by open squares, the values for samples with crosslinked polymer are shown as filled diamonds. It can be seen that for the samples in which polymer was not cross linked, the yield stress values increased exponentially as the percentage of the aqueous/aqueous emulsion decreased and the percentage of the dispersed oil phase increased. This was a good fit to theoretical prediction and indicates that the rheology in this non-crosslinked regime is dominated by the inherent foam-like structure of the high internal phase ratio emulsion.

By contrast, the yield stress values for the samples with crosslinked polymer showed a maximum yield stress at about 85% internal oil phase (i.e. 15% aqueous continuous phase). This was attributed to two effects which combined to reach this maximum value. As with the non-crosslinked samples, increasing amounts of the internal oil phase make an increasing contribution to yield stress and the increase in yield stress from 80 to 85% internal oil phase is attributed to this. However, as the amount of oil phase increases further, and the amount of aqueous continuous phase decreases, and so the amount of crosslinked polymer in the system also decreases, with a concomitant decrease of its strengthening effect on the system: this was the predominant effect when the percentage of dispersed internal oil phase exceeded 85 wt % and the percentage of the aqueous continuous phase fell below 15 wt %.

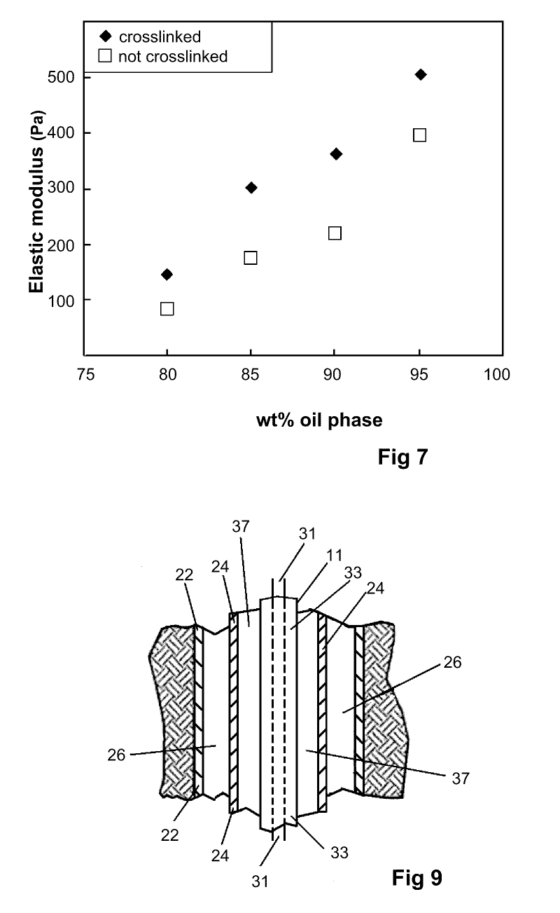

FIG. 7 shows elastic modulus values obtained through oscillatory rheological measurements for the same set of kerosene gel emulsions with varying oil/water ratio. These oscillatory measurements did not stress the compositions beyond their yield points. Both the crosslinked and non-crosslinked samples show the same overall trend with respect to elastic modulus—a linear increase with increasing percentage of the dispersed oil phase. The crosslinked samples consistently showed a significantly greater elastic modulus than the non-crosslinked samples.

### Formation of Viscous Gel Below Ground

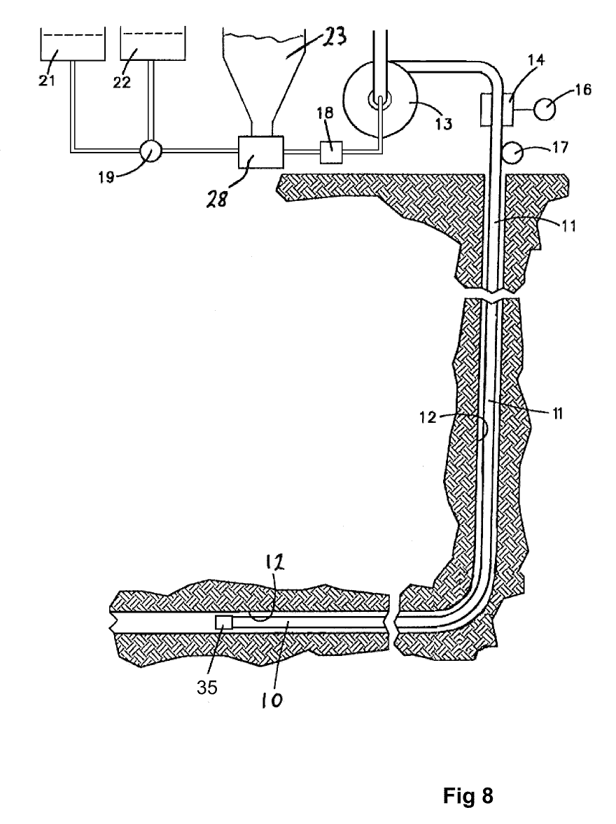

FIGS. 8 and 9 show equipment for placing a viscous emulsion at a desired location below ground. Coiled tubing 11 is used for delivery visa a wellbore. The tubing 11 is stored as a coil on a reel 13 from which it is drawn off to the extent required. The tubing 11 passes from the drum 13 through powered grippers 14 which function to control the extension or retraction of the tubing 11 within the well 12. Connected to the grippers 14 is a weight measuring scale 16 which permits the operator to determine the weight of the tube 11 supported by the grippers 14 at any given time. A measuring device 17 engages the surface of the tubing 11 and provides the operator with an indication of the length of the string, and consequently an indication of the position of the lower end of the tubing. The reel 13 and the grippers 14 are usually carried on a large road vehicle which is driven to the well site.

As shown by the detail view FIG. 9, the vertical part of the well is lined with a steel casing 22 within which there is a production tube 24 with annulus 26 between the production tube and the casing. At the bottom of the production tube 24, within a vertical part of the well, the annulus is closed with a packer (not shown). In this instance the well deviates horizontally to extend through an oil bearing zone of the reservoir. The coiled tubing 11 encloses a second tube 31 (not shown in FIG. 8). An annulus 33 is defined between the inner tube 31 and the tube 11.

Kerosene or other oil is pumped in at 30 to the axis of reel 13 and from there into the annulus 33 between the tubes 31 and 11. Supplies of water 21, surfactant 22 and thickening polymer 23 in powder form are connected through metering valves 19 to a mixer 28. These supplies are used to make a biphasic aqueous/aqueous emulsion which is driven by pump 18 into the inner tube 31. The aqueous/aqueous emulsion to provide the continuous phase of a viscous emulsion is thus pumped down through the inner tube 31 while the oil for the dispersed phase of an emulsion is pumped down the annulus 33 within the coiled tubing 11 which, as shown, extends down the wellbore 12. At the lower end of the coiled tubing, the oil is dispersed within the aqueous/aqueous emulsion by a mixer 35. The proportions of the fluids entering the tubing 31 and annulus 33 are regulated at the surface such that when they are mixed below ground by mixer 35, a viscous emulsion is formed with a high percentage of oil as its dispersed phase.

As an alternative to using coiled tubing with an inner tube within it, the coiled tubing 11 could carry the aqueous/aqueous emulsion while the kerosene or other oil was pumped down the annulus 37 created between the coiled tubing 11 and the production tube 24 (or between the coiled tubing 11 and the wellbore 12 if the horizontal portion of the wellbore 12 was an open hole).

1. A method of providing a viscous emulsion at a subterranean location accessible via a wellbore, comprising steps of:
providing an aqueous/aqueous emulsion comprising two aqueous solutions which, at surface temperature and pressure, are able to co-exist as separate aqueous phases in contact with each other, the two phases containing a plurality of dissolved solutes which segregate between the two phases such that at least one first solute is present at a greater concentration in the first aqueous phase than in the second aqueous phase while at least one second solute is present at a greater concentration in the second aqueous phase than in the first aqueous phase;
providing a hydrophobic liquid;
pumping both the hydrophobic liquid and the aqueous/aqueous emulsion down the wellbore to the subterranean location, and
causing or allowing the hydrophobic liquid to mix with the aqueous/aqueous emulsion before or after pumping them both down the wellbore.

2. The method of claim 1 wherein the biphasic mixture and the hydrophobic liquid are pumped separately down the wellbore so as to mix below ground and form an emulsion of the hydrophobic liquid dispersed in the biphasic mixture.

3. The method of claim 1 wherein said at least one first solute comprises a polymer.

4. The method of claim 3 wherein the polymer is selected from guar, hydroxyalkyl guar wherein the alkyl group contains from 1 to 4 carbon atoms and carboxymethylhydroxyalkyl guar wherein the alkyl group contains from 1 to 4 carbon atoms, polyacrylamide. polymethacrylamide, hydrolysed polyacrylamide, hydrolysed polymethacrylamide and copolymers of polyacrylamide or polymethacrylamide.

5. The method of claim 3 wherein said at least one second solute comprises a polymer or a surfactant.

6. The method of claim 5 wherein 1 said at least one second solute comprises a surfactant of the formula
R(OCH₂CH₂)ₙOH
where R denotes an alkyl or alkenyl group of at least 14 carbon atoms, especially a group containing 16 or 18 carbon atoms such as palmityl, stearyl or oleyl, and n has a mean value of at least 12.

7. The method of claim 1 wherein said first phase of the aqueous/aqueous emulsion is the dispersed phase and has thickening material concentrated therein and the second phase with said at least one second solute concentrated therein is the continuous phase.

8. The method of claim 1 wherein the ratio by volume of said first and second phases lies in a range from 60:40 to 40:60.

9. The method of claim 1 wherein the ratio by weight of said at least one first solute to said at least one second solute lies in a range from 2:1 to 2:3.

10. The method of claim 1 wherein the aqueous/aqueous emulsion or the hydrophobic liquid is pumped to the subterranean location through coiled tubing inserted within the wellbore.

11. The method of claim 1 wherein the hydrophobic liquid is a refined hydrocarbon.

12. The method of claim 1 wherein the viscous emulsion contains at least 50% by volume of the hydrophobic liquid.

13. The method of claim 1 wherein the viscous emulsion contains at least 74% by volume of the hydrophobic liquid.

14. The method of claim 3 further comprising a step of cross linking the polymer.

15. The method of claim 4 further comprising a step of cross linking the polymer.

16. A method of providing a viscous emulsion at a subterranean location accessible via a wellbore, comprising steps of:
providing an aqueous/aqueous emulsion comprising two aqueous solutions which, at surface temperature and pressure, are able to co-exist as separate aqueous phases in contact with each other, the two phases containing a plurality of dissolved solutes which segregate between the two phases such that at least one first solute which is a thickening polymer is present at a greater concentration in the dispersed aqueous phase than in the continuous aqueous phase while at least one second solute comprising surfactant is present at a greater concentration in the continuous aqueous phase than in the dispersed aqueous phase;
providing a hydrophobic liquid;
pumping both the hydrophobic liquid and the aqueous/aqueous emulsion down the wellbore to the subterranean location, and
causing or allowing the hydrophobic liquid to mix with the aqueous/aqueous emulsion after pumping them both down the wellbore, so as to form a viscous emulsion with the hydrophobic liquid as the dispersed phase thereof.

17. The method of claim 16 wherein the polymer is selected from guar, hydroxyalkyl guar wherein the alkyl group contains from 1 to 4 carbon atoms and carboxymethylhydroxyalkyl guar wherein the alkyl group contains from 1 to 4 carbon atoms, polyacrylamide. polymethacrylamide, hydrolysed polyacrylamide, hydrolysed polymethacrylamide and copolymers of polyacrylamide or polymethacrylamide.

18. The method of claim 16 wherein the aqueous/aqueous emulsion or the hydrophobic liquid is pumped to the subterranean location through coiled tubing inserted within the wellbore.

19. The method of claim 16 wherein the viscous emulsion contains at least 74% by volume of the hydrophobic liquid.

20. An emulsion comprising over 50% by volume of a hydrophobic phase dispersed within a continuous phase which is a aqueous/aqueous emulsion comprising two aqueous solutions which co-exist as separate aqueous phases in contact with each other, the two phases containing a plurality of dissolved solutes which segregate between the two phases such that at least one first solute is present at a greater concentration in the first aqueous phase than in the second aqueous phase while at least one second solute is present at a greater concentration in the second aqueous phase than in the first aqueous phase.

21. An emulsion according to claim 20 wherein the volume fraction occupied by the dispersed hydrophobic phase is over 74% of the total volume.

22. An emulsion according to claim 20 wherein said at least one first solute comprises a polymer.

23. An emulsion according to claim 18 wherein the polymer is crosslinked.

24. An emulsion comprising over 80% by volume of a hydrophobic phase dispersed within an aqueous continuous phase containing a crosslinked thickening polymer.

25. An emulsion according to claim 24 wherein the polymer is selected from guar, hydroxyalkyl guar wherein the alkyl group contains from 1 to 4 carbon atoms, carboxymethylhydroxyalkyl guar wherein the alkyl group contains from 1 to 4 carbon atoms, polyacrylamide, polymethacrylamide, hydrolysed polyacrylamide, hydrolysed polymethacrylamide and copolymers of polyacrylamide or polymethacrylamide.
